(19) United States
(12) Patent Application Publication
(10) Pub. No.: US 2024/0060624 A1
(43) Pub. Date: Feb. 22, 2024

(54) LIGHT SYSTEMS HAVING A DIFFUSIVE PVB INTERLAYER

(71) Applicant: SOLUTIA INC., ST. LOUIS, MO (US)

(72) Inventor: BERT JOZEF CAMPO, MELLE (BE)

(73) Assignee: SOLUTIA INC., ST. LOUIS, MO (US)

(21) Appl. No.: 18/260,380

(22) PCT Filed: Jan. 12, 2022
(86) PCT No.: PCT/US2022/012062

§ 371 Date: Jul. 5, 2023

Related U.S. Application Data
(60) Provisional application No. 63/141,623, filed on Jan. 26, 2021.

(51) Int. Cl. F21V 9/40; B32B 17/10

(52) U.S. Cl. CPC F21V 9/40; B32B 17/10036; B32B 17/10761; F21Y 2115/10

(57) ABSTRACT

Light systems are disclosed that comprise a translucent laminate diffuser, positioned adjacent a multipoint LED light source. The translucent laminate diffuser comprises a poly(vinyl butyral) polymer layer provided with one or more diffusion agents, and a stiff, transparent layer on each side of the poly(vinyl butyral) polymer layer. The translucent laminate diffuser exhibits suitable visible light transmission and diffusivity.

### FIELD OF THE INVENTION

This disclosure is related to the field of light systems and light box display systems provided with diffusive PVB interlayers.

### BACKGROUND OF INVENTION

The use of diffuser plates based on PMMA as in current billboard applications is hampered by long-term durability. Some of these, depending on use conditions, need to be exchanged as often as every 2 to 3 years. A glass laminate containing a light diffusive polyvinyl butyral (PVB) layer is a possible solution to this problem. Such a laminate may be expected to have a life cycle of at least 10 to 20 years.

U.S. Pat. No. 8,651,692 discloses an LED based lamp that comprises: an enclosure with an opening that comprises a light emission plane through which light is emitted from the lamp; a plurality of LEDs located along at least one wall of the enclosure and operable to generate light of a first wavelength range, wherein the LEDs are configured such that in operation their emission axis is oriented within a plane that is substantially parallel with or directed away from the light emission plane; and a first light reflective surface located on the base of the enclosure and configured such that in operation light is reflected through the light emission plane. A light emitting sign comprises the lamp of the invention with a light transmissive display surface overlying the light emission plane.

U.S. Pat. No. 8,833,964 discloses an elongated luminous element having a plurality of approximately point-shaped light sources disposed along a line and having light diffusion means deflecting at least one part of the light rays sent out by the light sources in a desired direction. The light diffusion means are disposed lateral to the main emitting direction of the light sources. The elongated luminous element is particularly suitable for installation in a light box for advertising or demonstration purposes. The light box has a transparent or partially transparent front side and a reflective back side.

U.S. Pat. No. 8,998,435 discloses a lighting device comprising a multistage lens which spectrally and spatially collimates the transmitted light. The illumination device is particularly well suited for use in a display unit.

PVB sheets are mostly applied as interlayers for laminated safety glass. The manufacturing process of such sheet generally comprises the mixing and extrusion of a formulation containing several organic compounds. The addition of certain components to the formulation will affect the visual aspect of the interlayer. In general, a perfectly clear result is desirable.

Laminated safety glass used in automobile windshields and architectural safety glass is typically composed of two sheets of glass laminated together with a plasticized polymer interlayer between them. Poly (vinylbutyral) (“PVB”) generally is the main component in the polymer interlayer. The poly(vinyl butyral) resin is combined with plasticizer, typically before melt extrusion to sheet. Poly(vinyl butyral) is obtained by reaction of poly(vinyl alcohol) and butyraldehyde. The properties of poly(vinyl butyral) are determined by its molecular structure which is characterized by parameters such as molecular weight and distribution thereof, residual hydroxyl content, and residual acetate content.

The following offers a simplified description of the manner in which multiple layer glass panels are generally produced in combination with these interlayers. First, at least one polymer interlayer sheet (single or multilayer) is placed between two substrates and any excess interlayer is trimmed from the edges, creating an assembly. It is not uncommon for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

U.S. Pat. No. 7,261,943 discloses a translucent interlayer, or a laminate obtained therefrom, that has low clarity, high haze, and light transmission of at least 60 percent, wherein the aesthetic qualities of etched or sandblasted glass are substantially recreated. U.S. Pat. No. 7,838,102 discloses a decorative interlayer, or a laminate obtained therefrom, wherein the aesthetic qualities can be matched to solid surface materials used in such applications as countertops, for example.

U.S. Pat. Publn. No. 2017/0043557 discloses an interlayer for a laminated glass that includes an interlayer film containing a polyvinyl acetal with an acetalization degree of 60 to 80 mol %, a content of a vinyl ester monomer unit of from 0.1 to 20 mol %, and a viscosity-average degree of polymerization of from 1400 to 4000, and light-diffusing fine particles having defined refractive indices with respect to the interlayer.

U.S. Pat. No. 9,840,068 discloses an interlayer film for laminated glass with which laminated glass having a gradation pattern with suppressed color irregularity can be prepared. The interlayer film for laminated glass includes a first resin layer containing a thermoplastic resin and a plasticizer and a second resin layer containing a thermoplastic resin, a plasticizer and inorganic particles.

JPWO2015190202A1 relates to a backlight device including a light-diffusing sheet. In one aspect, the light diffusing sheet is characterized in that the total light transmittance is 45% to 88%.

There remains a need for light systems having more durable light diffusers with high diffusivity and suitable light transmission.

### SUMMARY OF INVENTION

In one aspect, the invention relates to light systems that include a translucent laminate diffuser, positioned adjacent a multipoint LED light source. According to the invention, the translucent laminate diffuser typically comprises a poly(vinyl butyral) polymer layer comprising one or more diffusion agents, and a stiff, transparent layer on each side of the poly(vinyl butyral) polymer layer. In one aspect, the translucent laminate diffuser exhibits a visible light transmission value of from about 10% to about 30%; a diffusivity value, D, as defined herein, of at least 80. The invention further comprises the multipoint LED light source, which transmits light toward the translucent laminate diffuser.

Further aspects of the invention are as disclosed and claimed herein.

### BRIEF DESCRIPTION OF THE DRAWINGS

FIG. 1 depicts the way in which a Diffusivity Factor D may be determined;

FIG. 2 depicts the intensity of light that is deflected at certain angles (θ) when passing through various laminated PVB samples;

FIG. 3 depicts samples with varying contents of TiO2 (“Sample 1, 2 and 3”) characterized for light diffusion;

FIG. 4 depicts samples with either TiO₂ (formulation 4) or CaCO₃ (formulation 5) characterized for light diffusion TiO₂.

### DETAILED DESCRIPTION

The invention may be further understood according to the following further description.

In one aspect, the invention relates to light systems that include a translucent laminate diffuser, positioned adjacent a multipoint LED light source. When we say that the translucent laminate diffuser is positioned adjacent the multipoint LED light source, we do not mean that the two must be in physical contact, but rather that the two are functionally adjacent such that at least some of the light from the light source reaches the translucent laminate diffuser, for example through an optional translucent layer positioned between the multipoint LED light source and translucent laminate diffuser.

According to the invention, the translucent laminate diffuser may comprise a poly(vinyl butyral) polymer layer comprising one or more diffusion agents, and a stiff, transparent layer on each side of the poly(vinyl butyral) polymer layer. In aspects, the translucent laminate diffuser may exhibit a visible light transmission value of from about 10% to about 30%; and a diffusivity value, D, of at least 80. The multipoint LED light sources useful according to the invention transmit light toward the translucent laminate diffuser.

In one aspect, the light systems of the invention may further comprise a translucent layer, positioned between the multipoint LED light source and translucent laminate diffuser. The translucent layer, in turn, may comprise an image.

In various aspects, the stiff transparent layers of the invention may comprise glass or other stiff material, and the multipoint LED light source comprises a plurality of light-emitting diode chips.

In one aspect, the one or more diffusion agents comprise titanium dioxide. In another aspect, the translucent laminate diffuser exhibits a haze value of at least 95%.

In various aspects, the translucent laminate diffuser exhibits a visible light transmission value of from 12% to 28%, or from about 20% to about 25%, or from 22 to 24%.

In further aspects, the translucent laminate diffuser may exhibit a diffusivity value, D, of at least 85, or at least 90, or at least 92, or at least 95, as further described herein.

In yet another aspect, the translucent laminate diffuser exhibits a visible light transmission value of from 12% to 28%, and a diffusivity value, D, of at least 85. In a further aspect, the translucent laminate diffuser exhibits a visible light transmission value of from 20% to 25%, and a diffusivity value, D, of at least 50.

As further described below, the percent haze of the translucent laminate diffusers is typically greater than 95%, or greater than 96%, or greater than 97%, or greater than 98%, or greater than 99% (as measured by ASTM D1003-61 (Re-approved 1977)—Procedure A using Illuminant C, at an observer angle of 2 degrees).

Thus, in further aspects, the translucent laminate diffuser exhibits a visible light transmission value of from 12% to 28%, and a diffusivity value, D, of at least 85, and a haze value that is greater than 96%. In a further aspect, the translucent laminate diffuser exhibits a visible light transmission value of from 20% to 25%, and a diffusivity value, D, of at least 50, and a haze value that is greater than 98%.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In one aspect, the light systems of the invention comprise a light source, which is a multipoint LED light source. According to the invention, the multipoint LED light source may comprise a plurality of light-emitting diode chips which generate light during operation. These light-emitting diode chips are typically the light-generating element of the multipoint LED light source. The light source can generate colored, multicolored or white light, for example. According to the invention, the light source can comprise light-emitting diode chips of the same type or else different light-emitting diode chips, which generate light of different colors during operation. In one aspect, these LEDs may be fitted on one or more LED modules, for example an SMD (surface mounted device) or a COB (chip on board). In one aspect, white LEDs, for example in the form of RGB modules and/or dye-converted LEDs, are used.

The multipoint LED light source of the invention is distinguished from traditional fluorescent lighting panels such as those comprising an enclosure housing one or more fluorescent tubes and a front diffusing panel. Such diffusing panels may be made from a translucent plastic material or a light transmissive plastic material with a surface pattern to promote a uniform light emission.

White light emitting LEDs (“white LEDs”) such as those useful according to the invention are known in the art and are a relatively recent innovation. As disclosed, for example, in U.S. Pat. No. 5,998,925, white LEDs may include one or more phosphor materials, that is photo-luminescent materials, which absorb a portion of the radiation emitted by the LED and re-emit radiation of a different color (wavelength).

Typically, these LED chips generate blue light and the phosphor material(s) absorbs a proportion of the blue light and re-emit light of a different color typically yellow or a combination of green and red light, green and yellow light or yellow and red light. The portion of the blue light generated by the LED that is not absorbed by the phosphor material combined with the light emitted by the phosphor material provides light which appears to the eye as being nearly white in color.

Due to their long operating life and high luminous efficacy, high brightness white LEDs are increasingly being used to replace conventional fluorescent, compact fluorescent and incandescent bulbs. Today, most lighting fixture designs utilizing an array of white LEDs. Moreover, due to their compact size, compared with conventional light sources, white LEDs offer the potential to construct novel and compact lighting fixtures.

However, these multipoint LED light sources light unevenly, especially when the light is adjacent the surface to be lit, with pinpoints of light being clearly discernible, thus the need for a translucent laminate diffuser.

In another aspect, the light systems of the invention comprise a translucent layer, positioned between the multipoint LED light source and the translucent laminate diffuser. The translucent layer, in turn, may comprise an image. The translucent layer of the invention is not at all limited, and may comprise a layer of any material that is translucent.

In another aspect, the light systems of the invention may thus comprise an image. According to the invention, this image may be, for example, printed onto a translucent film which serves as the translucent layer of the invention, the image itself also being translucent, such that at least a portion of the light projected from the multipoint LED light source may be seen, and in fact passes through the image itself. With respect to this image, the multipoint LED light source thus comprises a back-lit lighting configuration such as is used in signage such as smaller format billboards, in which a light transmissive display surface or image overlies the opening of the light-box enclosure. This display surface is thus in the form of an image printed on a translucent film in which the printed image acts as a light transmissive color filter. Where the sign comprises symbols, characters or simple devices as opposed to complex images it is known to use colored acrylic, polycarbonate, or other plastics materials to form the required image. These materials are typically not very durable, and with demanding uses such as modern images in which great detail is desired, may not present a visually satisfactory or distinct image. According to the invention, a translucent laminate diffuser is provided that displays uniform diffusivity, while providing increased durability and lifetime.

In another aspect, the light systems of the invention further comprise a translucent laminate diffuser, for example a diffusive PVB layer adjacent the light source, or between the image and the light source. According to the invention, a translucent laminate diffuser is provided which diffuses the light from the multipoint LED light source, so that the resulting visual properties are appropriate for the PVB interlayer to be applied for the purpose of serving as a back light diffuser plate, which is in place to evenly spread light, for example in billboards with backlighting by LED strips. These diffusive PVB interlayer sheets include a PVB polymer, at least one diffusion agent, and at least one plasticizer.

The translucent laminate diffusers of the invention typically comprise a PVB resin, one or more diffusion agents, and at least one plasticizer. These diffusers typically comprise a stiff transparent substrate on each side, preferably glass.

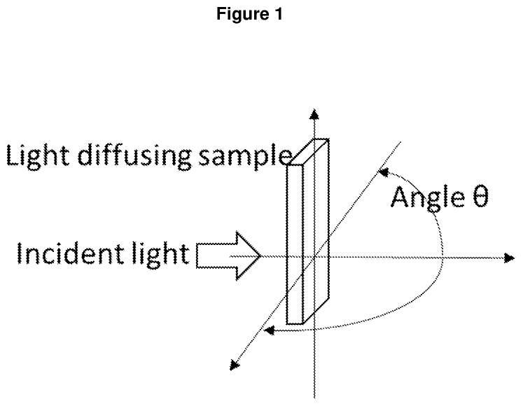

According to the invention, excellent diffusivity is required in the translucent laminate diffusers of the invention, in order to obtain the clarity of the image in the light systems of the invention. Thus, turning now to FIG. 1, for this work, a diffusion factor D was calculated, as the percentage of light that is diverted on average to angles of 60 and 20 degrees, relative to light diverted at an angle of 10 degrees according to the following:

$$\\ Diffusion factor D D = \frac{( {I}_{60 +} + {I}_{20} ) / 2}{{I}_{10}} * 100$$

wherein I is the measured light intensity at a given angle.

According to the invention, the diffusion factor D of the translucent laminate diffusers of the invention may be at least about 90, or at least about 88, or at least 85, or at least 80, or as described elsewhere herein.

In embodiments, the percent haze of the translucent laminate diffusers is typically greater than 95%, or greater than 96%, or greater than 97%, or greater than 98%, or greater than 99% (as measured by ASTM D1003-61 (Re-approved 1977)—Procedure A using Illuminant C, at an observer angle of 2 degrees).

Transparency, as expressed in percent visual transmittance (% Tvis), is also used to describe the translucent laminate diffusers disclosed herein. The transparency is also measured with a hazemeter, such as Model D25 available from Hunter Associates (Reston, VA), and in Illuminant D65, at an observer angle of 10 degrees. The polymer interlayers are laminated with a pair of clear glass sheets each of 2.3 mm thick (commercially available from Pittsburgh Glass Works of Pennsylvania) and the % Tvis is measured. The polymer interlayers of the present disclosure have a % Tvis of greater than 15%, 20%, or greater than 25%, or greater than 30% for the interlayers containing only additives of ACAs, UV stabilizers, and antioxidant, or greater than 15% or greater than 20%, or greater than 25% for the interlayers containing additional additives such as IR absorbers or blockers as mentioned above.

The glass transition temperature (Tg) of the PVB resins of the translucent laminate diffusers of the invention may be determined by dynamical mechanical thermal analysis (DMTA). The DMTA measures the storage (elastic) modulus (G′) in Pascals, loss (viscous) modulus (G″) in Pascals, tan delta (=G″/G′) of the specimen as a function of temperature at a given frequency, and temperature sweep rate. A frequency of 1 Hz and temperature sweep rate of 3° C./min were used herein. The Tg is then determined by the position of the tan delta peak on the temperature scale in ° C.

The PVB resin may be produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B. E. Wade (2003), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in PVB refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual hydroxyl content and residual acetate content is measured on a weight percent (wt. %) basis per ASTM D1396.

The PVB resins of the present disclosure typically have a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art. Although the embodiments described below refer to the polymer resin as being PVB, it would be understood by one of ordinary skill in the art that the polymer may be any polymer suitable for use in a multiple layer panel. Typical polymers include, but are not limited to, polyvinyl acetals (PVA) (such as poly(vinyl butyral) (PVB) or isomeric poly(vinyl isobutyral) (PVisoB), polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomeric polymer PVisoB, polyvinyl chloride, and polyurethane are particularly useful polymers generally for interlayers; PVB (and its isomeric polymer) is particularly preferred.

In a further aspect, the diffusive interlayer can be a multilayered interlayer. For example, the multilayered interlayer can consist of PVB//PVisoB//PVB. Other example includes PVB//PVC//PVB or PVB//PU//PVB. Further examples include PVC//PVB//PVC or PU//PVB//PU. Alternatively, the skin and core layers may all be PVB using the same or different starting PVB resins.

The diffusive PVB layer further comprises at least one diffusion agent, preferably a white diffusion agent, for example one or more of barium sulfate, magnesium sulfate, magnesium oxide, magnesium silicate, titanium dioxide, zinc oxide, zinc sulfate, antimony oxide, calcium phosphate, calcium sulfate, calcium carbonate, and mixtures thereof, and stoichiometric variants thereof.

According to the invention, the diffusion agent concentration may be a function of the desired % VLT. For example the concentration may be such as to provide a % VLT of no more than 10, or no more than 15, or no more than 20, or no more than 30%, or from 20 to 23 or from 23 to 26.

In another aspect, the diffusion agent concentration may be described as a wt %, for example from about 1 to about 10, or from 2 to 5, or from 3 to 8 wt. %. When the diffusion agent comprises titanium dioxide, the amount may vary from about 1 to about 2%. In other aspects, the interlayer may comprise from about 0.05 to 2.5 parts per hundred resin of a diffusion agent such as titanium dioxide, or from about 0.5 to 2.5 phr, or 0.01 phr or greater, or 0.02 phr, or 0.03 phr or greater, or 0.04 phr resin or greater, or 0.05 phr or greater, or 0.06 phr or greater, or 0.07 phr or greater, or 0.08 phr or greater, or 0.09 phr or greater, or 0.1 phr or greater, or 5.0 phr or less, or 4.9 phr or less, or 4.8 phr or less, or 4.7 phr or less, or 4.6 phr or less, or 4.5 phr or less, or 4.4 phr or less, or 4.3 phr or less, or 4.2 phr or less, or 4.1 phr or less, or 4.0 phr or less, or 3.9 phr or less, or 3.8 phr or less, or 3.7 phr or less, or 3.6 phr or less, or 3.5 phr or less, or 3.4 phr or less, or 3.3 phr or less, or 3.2 phr or less, or 3.1 phr or less, or 3.0 phr or less, or 2.9 phr or less, or 2.8 phr or less, or 2.7 phr or less, or 2.6 phr or less, or 2.5 phr or less, or 2.4 phr or less, or 2.3 phr or less, or 2.2 phr or less, or 2.1 phr or less, or 2.0 phr or less.

In case Titanium oxide is used as a diffusive agent (such as in the examples), the average particle size may be, for example, from about 100 to 500 nm, or from 150 to 450 nm, or from 200 nm to 300 nm.

The term “plasticizer” as used herein refers generally to a molecule or blend of molecules, as further described herein, that plasticizes a polymer, specifically poly(vinyl butyral), thereby softening it.

Plasticizers work by embedding themselves between chains of polymers, spacing them apart (increasing the “free volume”) and thus significantly lowering the glass transition temperature (Tg) of the polymer resin (typically by 0.5-4.degree. C./phr), making the material softer. In this regard, the amount of plasticizer in the interlayer can be adjusted to affect the glass transition temperature (Tg). The Tg is the temperature that marks the transition from the glassy state of the interlayer to the rubbery state. In general, higher amounts of plasticizer loading will result in lower Tg. Conventional interlayers generally have had a Tg in the range of about 0° C. for acoustic (noise reducing) interlayers to about 45° C. for hurricane and aircraft interlayer applications.

In some embodiments, the plasticizer has a hydrocarbon segment of fewer than 20, fewer than 15, fewer than 12, or fewer than 10 carbon atoms. Suitable plasticizers for use according to the invention include esters of a polybasic acid or a polyhydric alcohol, among others. Suitable plasticizers include, for example, triethylene glycol bis(2-ethylhexanoate) (“3-GEH”), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl)adipate, bis(2-ethoxyethyl)adipate, bis(2-butoxyethyl)adipate, dioctyl adipate, hexyl cyclohexyladipate, diisononyl adipate, heptylnonyl adipate, dibutyl sebacate, polymeric adipates, soybean oils, and epoxidized soybean oils, and mixtures thereof. A more preferred plasticizer is 3-GEH. Additionally, plasticizers that are compatible in high temperatures may be preferred to further increase the flow of the interlayer.

In embodiments, the plasticizers used herein may be selected from dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, and mixtures thereof. In embodiments, the plasticizer may be a mix of two or more plasticizers.

In various embodiments of interlayers of the present disclosure, the interlayer may comprise about 20 to about 60 phr (parts per hundred parts resin) total plasticizer.

In various embodiments of interlayers of the present disclosure, the interlayer comprises greater than 5 phr, about 5 to about 120 phr, about 10 to about 90 phr, about 20 to about 70 phr, about 30 to about 60 phr, or less than 120 phr, or less than 90 phr, or less than 60 phr, or less than 40 phr, or less than 30 phr total plasticizer.

The interlayer may be a monolithic interlayer or a multi-layer interlayer

While the total plasticizer content is indicated above, the plasticizer content in the skin layer(s) or core layer(s) can be different from the total plasticizer content. In addition, the skin layer(s) and core layer(s) can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference). For example, at equilibrium the interlayer could comprise two skin layers, each with 30 phr plasticizer, and a core layer with 65 phr plasticizer, for a total plasticizer amount for the interlayer of about 45.4 phr when the combined skin layer thickness equals that of the core layer. For thicker or thinner skin layers, the total plasticizer amount for the interlayer would change accordingly. In various embodiments of the present invention, the plasticizer content of the core layer and skin layer differs by at least 8 phr, or at least 9 phr, or at least 10 phr, or at least 12 phr, or at least 13 phr, or at least 14 phr, or at least 15 phr, or at least 16 phr, or at least 17 phr, or at least 18 phr, or at least 19 phr, or at least 20 phr, or at least 25 phr or more. As used herein, the amount of plasticizer, or any other component in the interlayer, can be measured as parts per hundred parts resin (phr), on a weight per weight basis. For example, if 30 grams of plasticizer is added to 100 grams of polymer resin, then the plasticizer content of the resulting plasticized polymer would be phr. As used herein, when the plasticizer content of the interlayer is given, the plasticizer content is determined with reference to the phr of the plasticizer in the mix or melt that was used to produce the interlayer.

The terms “polymer interlayer sheet,” “interlayer,” and “polymer melt sheet” as used herein, generally may designate a single-layer sheet or a multilayered interlayer. A “single-layer sheet,” as the name implies, is a single polymer layer extruded as one layer. A multilayered interlayer sheet, on the other hand, may comprise multiple layers, including separately extruded layers, co-extruded layers, or any combination of separately and co-extruded layers. Thus the multilayered interlayer sheet could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of a single-layer sheet and a plural-layer sheet; and a combination of at least one plural-layer sheet and at least one co-extruded sheet. In various embodiments of the present disclosure, a multilayered interlayer sheet comprises at least two polymer layers (e.g., a single layer or multiple layers co-extruded and/or laminated together) disposed in direct contact with each other, wherein each layer comprises a polymer resin, as detailed more fully below. As used herein for multilayer interlayers having at least three layers, “skin layer” generally refers to the outer layers of the interlayer and “core layer” generally refers to the inner layer(s). Thus, one exemplary embodiment would be: skin layer//core layer//skin layer.

It is contemplated that polymer interlayer sheets as described herein may be produced by any suitable process known to one of ordinary skill in the art of producing polymer interlayer sheets that are capable of being used in a multiple layer panel (such as a glass laminate or glass panel). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminates of the present invention are formed using processes known in the art.

Generally, in its most basic sense, extrusion is a process used to create objects of a fixed cross-sectional profile. This is accomplished by pushing or drawing a material through a die of the desired cross-section for the end product. Generally, in the extrusion process, thermoplastic resin and plasticizers, including any of those resins, plasticizers and other additives described above such as diffusion agents, are pre-mixed and fed into an extruder device. Any additives such as UV inhibitors (in liquid, powder, or pellet form) are often used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material, plasticizer, diffusion agents, and any other additives described above, are further mixed and melted, resulting in a melt that is generally uniform in temperature and composition. Once the melt reaches the end of the extruder device, the melt is propelled into the extruder die. The extruder die is the component of the thermoplastic extrusion process which gives the final polymer interlayer sheet product its profile. Generally, the die is designed such that the melt evenly flows from a cylindrical profile coming out of the die and into the product's end profile shape. A plurality of shapes can be imparted to the end polymer interlayer sheet by the die so long as a continuous profile is present.

The polymer interlayer at the state after the extrusion die forms the melt into a continuous profile will be referred to as a “polymer melt sheet.” At this stage in the process, the extrusion die has imparted a particular profile shape to the thermoplastic resin, thus creating the polymer melt sheet. The polymer melt sheet is highly viscous throughout and in a generally molten state. In the polymer melt sheet, the melt has not yet been cooled to a temperature at which the sheet generally completely “sets.” Thus, after the polymer melt sheet leaves the extrusion die, generally the next step in presently employed thermoplastic extrusion processes is to cool the polymer melt sheet with a cooling device. Cooling devices utilized in the previously employed processes include, but are not limited to, spray jets, fans, cooling baths, and cooling rollers. The cooling step functions to set the polymer melt sheet into a polymer interlayer sheet of a generally uniform non-molten cooled temperature. In some embodiments, the polymer melt sheet may be embossed after leaving the die, and prior to the cooling step, as previously discussed. In contrast to the polymer melt sheet, this polymer interlayer sheet is not in a molten state and is not highly viscous. Rather, it is the set final-form cooled polymer interlayer sheet product. For the purposes of this application, this set and cooled polymer interlayer will be referred to as the “polymer interlayer sheet.”

In some embodiments of the extrusion process, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film. Generally, as used herein, a polymer film is thinner than a polymer sheet, such as from about 0.001 to 0.2 mm thick.

The interlayers of the present disclosure will most commonly be utilized in multiple layer panels comprising two substrates, such as a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise multilayered interlayers, as noted above. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between 135° C. and 150° C. and pressures between 180 psig and 200 psig for about 30 to 90 minutes. The actual steps, as well as the times and temperatures, may vary as necessary, as known by one skilled in the art.

Other means for use in de-airing of the interlayer-glass interfaces (steps 2-5) known in the art and that are commercially practiced include vacuum bag and vacuum ring processes in which a vacuum is utilized to remove the air.

The resulting sheet may thus be a single layer or may be a multilayer sheet. The final interlayer, whether formed from extrusion or co-extrusion, generally has a random rough surface topography as it is formed through melt fractures of polymer melt as it exits the extrusion die and may additionally be embossed over the random rough surface on one or both sides (e.g., the skin layers) by any method of embossment known to one of ordinary skill in the art.

Generally, the thickness, or gauge, of the polymer interlayer sheet will be in a range from about 15 mils to 100 mils (about 0.38 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm).

The term “poly(vinyl butyral) multilayer sheet,” as used herein, refers to a sheet comprised of different layers of poly(vinyl butyral) resins, typically a soft or core layer, having a stiff, or skin, layer on each side of the core layer. The poly(vinyl butyral) multilayer sheets of the invention thus comprise at least one soft poly(vinyl butyral) and at least one stiff poly(vinyl butyral).

In an embodiment, the multilayered interlayers may comprise: a first skin polymer layer comprising plasticized poly(vinyl butyral) having a molecular weight of less than about 140,000 Daltons; a second core polymer layer comprising plasticized poly(vinyl butyral) having a molecular weight of greater than about 140,000 Daltons; and a third skin polymer layer comprising plasticized poly(vinyl butyral) having a molecular weight of less than about 140,000 Daltons. The second polymer layer is disposed between the first polymer layer and the third polymer layer, resulting in two skin layers and a central core layer.

Thus, in one aspect, the multilayered poly(vinyl butyral) sheets of the invention may comprise interlayers comprising one or more skin layers and a core layer(s). In an embodiment, these multilayered interlayer sheets may comprise: a first polymer layer (skin layer) comprising a plasticized poly(vinyl butyral) resin; a second polymer layer (core layer) comprising a plasticized poly(vinyl butyral) resin, or a blend thereof having the same or different residual hydroxyl content; and a third polymer layer (skin layer) comprising plasticized poly(vinyl butyral) resin. The second or core polymer layer is disposed adjacent the first polymer layer. If there are three or more layers, the second polymer layer may be disposed between the first polymer layer and the third polymer layer, resulting in two skin layers and a central core layer.

The diffusion agent/diffusive agent leading to the desired/targeted diffusive properties for application as diffuser laminate can be added to one or more of the layers in a multi-layer sheet

An interlayer's glass transition temperature is also correlated with the stiffness of the interlayer—the higher the glass transition temperature, the stiffer the interlayer. Generally, an interlayer with a glass transition temperature of 30° C. or higher increases windshield strength and torsional rigidity. A soft interlayer (generally characterized by an interlayer with a glass transition temperature of lower than 30° C.), on the other hand, contributes to the sound dampening effect (i.e., the acoustic characteristics). The multilayered interlayers of the present disclosure combine these two advantageous properties (i.e., strength and acoustic) by utilizing harder or stiffer skin layers laminated with a softer core layer (e.g., stiff//soft//stiff), with the skin layers having increased flow at autoclave temperatures. In various embodiments, the multilayered interlayers generally comprise skin layers with a glass transition temperature of about 30° C. to about 55° C. and core layer(s) with a glass transition temperature of about 0° C. to about 10° C.

The diffusive laminate can be applied in combination with LED light strips in other constructions as lightboxes for billboards, e.g. as (part of) partitions in building walls or ceilings, or as part of lighting elements in walls or ceilings, or even outdoor uses.

This invention can be further illustrated by the following examples of embodiments thereof, although it will be understood that these examples are included merely for purposes of illustration and are not intended to limit the scope of the invention unless otherwise specifically indicated.

### EXAMPLES

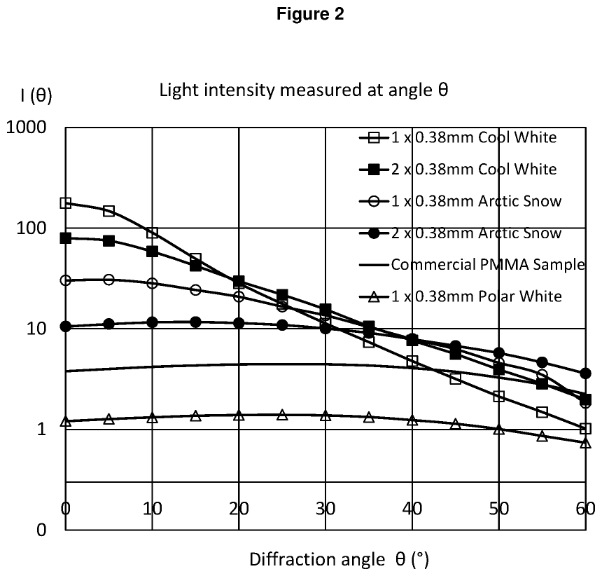

PVB interlayers with certain light diffusive properties are currently available on the market. Several existing products such as Vanceva cool white (2180), arctic snow (2165) and polar white (2207), all available from Eastman Chemical Company, were characterized by measuring the intensity of light that is deflected at a certain angle (8) when passing through laminated PVB samples. Commercially available light diffusive PMMA samples were obtained from the market and characterized in a similar way. Results are displayed in FIG. 2 and table 1 below. With the current state of the art for PVB interlayers, either the diffusion factor D is not near the range for the diffusion factor of the commercial PMMA sample, or the light transmission (“Y”) is significantly lower if diffusion factor D is of comparable magnitude.

The Vanceva whites products are made with addition of TiO2 or CaCO3 as an additive to produce the desired visual aspect. See FIG. 2, which depicts the diffusion characteristics of commercially available PVB products. You will note that the light transmission of these examples is relatively low, or else the diffusivity is deficient. According to the invention, we provide a high diffusivity with suitable light transmission.

TABLE 1

| | Diffuser | % VLT | |
|---|---|---|---|
| Sample | thickness (mm) | (Y) | DF |
| Vanceva Cool White | 0.38 | 80.7 | 16.3 |
| Vanceva Cool White | 0.76 | 73.6 | 27.1 |
| Vanceva Arctic White | 0.38 | 64.6 | 40.0 |
| Vanceva Arctic White | 0.76 | 50.7 | 64.7 |
| Vanceva Polar White | 0.38 | 10.1 | 80.6 |
| Commercial PMMA based diffuser | 3.0 | 26.8 | 79.7 |
| plate | | | |

### Example 1

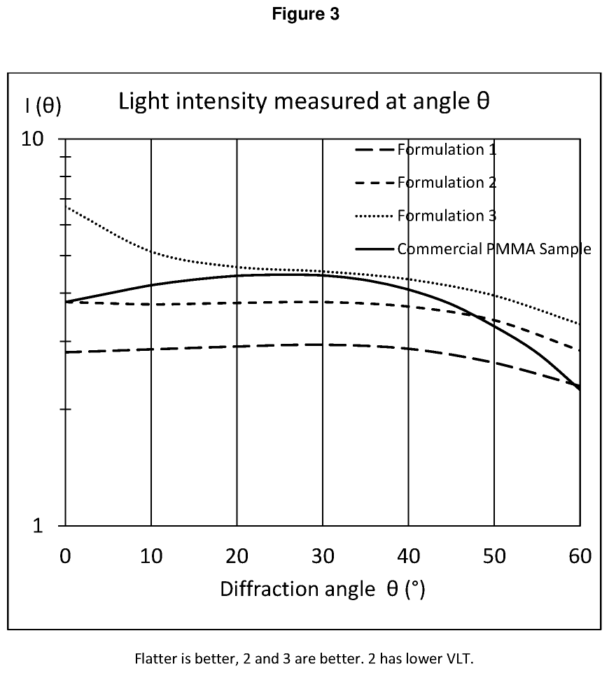

Samples with varying content of TiO2 (“Sample 1, 2 and 3”) were prepared. Samples were laminated with 2 mm standard float glass and characterized for light diffusion, the result is shown in FIG. 3. The light diffusion factor D was calculated and is displayed with light transmission data in table 2 below. As seen in FIG. 3 and table 2 below, the samples with experimental formulations indicate that higher or comparable diffusion factors can be obtained with comparable light transmission, relative to the commercial PMMA sample.

Also, visual assessment of laminated samples 1 and 2, compared to the PMMA sample with LED back lighting, showed similar performance. These data and observations further indicate that novel formulations have been identified to allow the production of PVB sheet with appropriate light transmission and diffusion factors to serve as translucent laminate diffuser interlayers in applications for back light diffuser plates in billboards with LED light strips as a light source. PVB sheet from these formulations can also serve as interlayer for laminated glass diffuser plates in other applications with back lighting and/or other configurations.

TABLE 2

| Formulation/Sample # | PVB thickness (mm) | % VLT (Y) | DF |
|---|---|---|---|
| 1 | 0.38 | 21.3 | 91.1 |
| 2 | 0.38 | 25.7 | 88.4 |
| 3 | 0.38 | 30.6 | 78.0 |
| 4 | 0.39 | 25.2 | 92.8 |
| 5 | 0.38 | 72.6 | 23.9 |

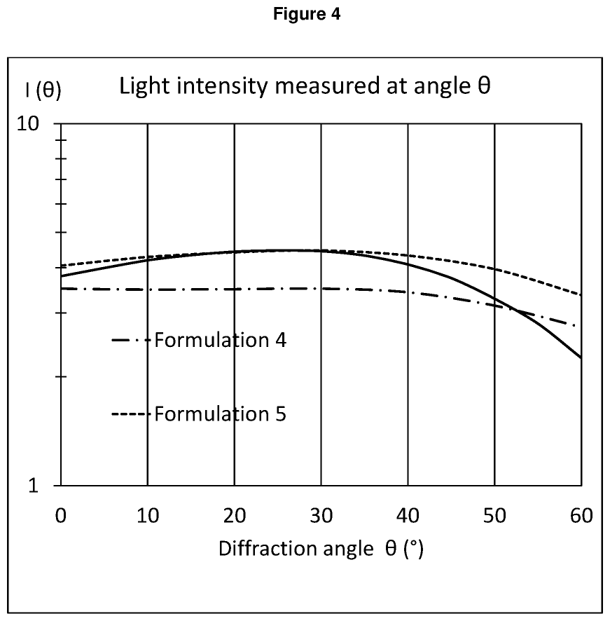

The samples in Table 3 were prepared by addition of TiO₂ (formulation 4) or CaCO₃ (formulation 5) to a PVB formulation. Characterization of light diffusion is displayed in FIG. 4. Because the very high content of CaCO₃ that is required to come to desired transmission and diffusive properties at this thickness, it was decided to focus on TiO₂ as additive for the targeted application in billboards.

Lab samples were produced by preparing mixtures of PVB, plasticizer and TiO2 or CaCO₃ in specific ratios.

The amount of fresh PVB resin, S-2075 and TiO2 or CaCO3 was adapted to come to a total composition as displayed in the table 3 below. Each composition was passed through a lab extruder and converted to PVB film. PVB samples were laminated with 2 mm standard float glass and characterized for light transmission, color, % haze and light diffusion.

TABLE 3

| | | | | | PVB | | | | | |
|---|---|---|---|---|---|---|---|---|---|---|
| | | | | | Thickness | | | | | |
| Formulation | % resin | % S2075 | % CaCO3 | % TiO2 | (mm) | Y (% LT) | L* | a* | b* | % haze |
| 4 (lab case 6) | 70.94 | 27.51 | 0 | 1.45 | 0.39 | 25.17 | 57.24 | 0.65 | 6.1 | 99.1 |
| 5 (lab case 8) | 43.43 | 27.51 | 28.95 | 0.00 | 0.38 | 29.42 | 61.15 | 0.07 | 4.9 | 99.27 |

Samples were prepared, typically 100 parts of PVB resin mixed with 38 parts of plasticizer. 2.8 phr of TiO2 was added to the formulation. The samples collected during flush-in will have formulation with TiO₂ content between 0 and 2.8 phr, based on the results the formulations 1, 2, 3 are expected to have a TiO₂ content of about 2% or 1.4 phr.

1. A light system, comprising:
a) a translucent laminate diffuser, positioned adjacent a multipoint LED light source, the translucent laminate diffuser comprising:
i) a poly(vinyl butyral) polymer layer comprising one or more diffusion agents, and
ii) a stiff, transparent layer on each side of the poly(vinyl butyral) polymer layer, wherein the translucent laminate diffuser exhibits:
(1) a visible light transmission value of from about 10% to about 30%;
(2) a diffusivity value, D, of at least 80; and
b) the multipoint LED light source, which transmits light toward the translucent laminate diffuser.

2. The light system of claim 1, further comprising a translucent layer, positioned between the multipoint LED light source and translucent laminate diffuser.

3. The light system of claim 2, wherein the translucent layer comprises an image.

4. The light system of claim 1, wherein the stiff transparent layers comprise glass.

5. The light system of claim 2, wherein the multipoint LED light source comprises a plurality of light-emitting diode chips.

6. The light system of claim 1, wherein the one or more diffusion agents comprise one or more of: barium sulfate, magnesium sulfate, magnesium oxide, magnesium silicate, titanium dioxide, zinc oxide, zinc sulfate, antimony oxide, calcium phosphate, calcium sulfate, or calcium carbonate.

7. The light system of claim 1, wherein the one or more diffusion agents comprise titanium dioxide.

8. The light system of claim 1, wherein the translucent laminate diffuser exhibits a haze value of at least 98%.

9. The light system of claim 1, wherein the translucent laminate diffuser exhibits a visible light transmission value of from 12% to 28%.

10. The light system of claim 1, wherein the translucent laminate diffuser exhibits a visible light transmission value of from about 20% to about 25%.

11. The light system of claim 1, wherein the translucent laminate diffuser exhibits a diffusivity value, D, of at least 85.

12. The light system of claim 1, wherein the translucent laminate diffuser exhibits a diffusivity value, D, of at least 90.

13. The light system of claim 1, wherein the translucent laminate diffuser exhibits a diffusivity value, D, of at least 92.

14. The light system of claim 1, wherein the diffusivity value, D, is calculated as the percentage of light that is diverted on average to angles of 60 and 20 degrees, relative to light diverted at an angle of 10 degrees, according to the following:
$$\\ Diffusion factor D D = \frac{( {I}_{60 +} + {I}_{20} ) / 2}{{I}_{10}} * 100$$
wherein I is the measured light intensity at a given angle.
